(19) United States
(12) Patent Application Publication
(10) Pub. No.: US 2007/0261002 A1
(43) Pub. Date: Nov. 8, 2007

(54) SYSTEM AND METHOD FOR CONTROLLING A PORTABLE ELECTRONIC DEVICE

(75) Inventors: Chin-Hwa Hu, Taipei County (TW); Chao-Lung Lee, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/744,903

(22) Filed: May 7, 2007

Related U.S. Application Data
(60) Provisional application No. 60/746,655, filed on May 8, 2006.

(51) Int. Cl. G06F 3/048

(52) U.S. Cl. 715/810

(57) ABSTRACT

A portable electronic device is provided. The portable electronic device comprises a touch screen, a storage device, a pointer generator, an icon generator, and a controller. The touch screen provides a waiting screen. The storage device stores a plurality of entry functions corresponding to items arranged in a hierarchical menu, wherein each of the entry functions operates to display a respective screen on the touch screen. The pointer generator generates a pointer directing to one of the entry functions regardless of the position in the hierarchical menu of the corresponding item. The icon generator generates a shortcut icon, associated with the pointer, on the waiting screen. The controller determines whether the shortcut icon is manipulated in a predetermined way, and if so, activates the entry function corresponding to the manipulated shortcut icon.

### CROSS REFERENCE TO RELATED APPLICATIONS

This application claims priority of U.S. Provisional Patent Application Ser. No. 60/746,655, filed May 8, 2006. The contents of the provisional applications are hereby incorporated by reference.

### BACKGROUND

The invention relates to portable electronic devices, and in particular to methods and systems of controlling a portable electronic device.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

Generally, mobile phones have call-related functions and various additional functions. In such a mobile phone, access to these functions is arranged in a hierarchical menu for viewing and selection.

The hierarchical menu, however, displayed on multiple screens. To execute a function, a user scrolls through the hierarchical menu to execute the desired function. The operations are complicated due to complex key operations.

For example, an incoming call is unanswered. To view a list of unanswered call(s), multiple screens are scrolls through in the hierarchical menu. Referring to FIG. 1, a waiting screen 11 is displayed by default. A main menu 13 is displayed in response to a user command. When an item, such as a ‘call record’ item, is selected from the main menu 13, contents of the selected item are further displayed correspondingly. For example, a call record 15, comprising a plurality of selectable entries each corresponding to a function, is displayed. The “call record 15” menu item comprises entries corresponding to the functions enabled by a call-related application, such as a unanswered call viewing function, a dialed numbers viewing function, a received call viewing function, a deleted call log viewing function, a call time viewing function, a call cost calculating function, and an SMS (short message system) counter. When the user selects the unanswered call viewing function, a list of unanswered calls 17 is displayed. Unanswered calls displayed in the list can be selected, and further operation can be implemented.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of controlling a portable electronic device is provided. A waiting screen is provided on a touch screen. A plurality of entry functions corresponding to items arranged in a hierarchical menu is provided, wherein each of the entry functions operates to display a respective screen. A pointer is provided, directing to one of the entry functions regardless of the position in the hierarchical menu of the corresponding item. A shortcut icon, associated with the pointer, is provided on the waiting screen. The entry function is activated when the shortcut icon is manipulated in a predetermined way.

Also provided is a portable electronic device. The portable electronic device comprises a touch screen, a storage device, a pointer generator, an icon generator, and a controller. The touch screen provides a waiting screen. The storage device stores a plurality of entry functions corresponding to items arranged in a hierarchical menu, wherein each of the entry functions operates to display a respective screen on the touch screen. The pointer generator generates a pointer directing to one of the entry functions regardless of the position in the hierarchical menu of the corresponding item. The icon generator generates a shortcut icon, associated with the pointer, on the waiting screen. The controller determines whether the shortcut icon is manipulated in a predetermined way, and if so, activates the entry function corresponding to the manipulated shortcut icon.

### BRIEF DESCRIPTION OF DRAWINGS

The invention can be more fully understood by reading the subsequent detailed description and examples with references made to the accompanying drawings, wherein:

FIG. 1 illustrates operations for activating a function in a conventional mobile phone;

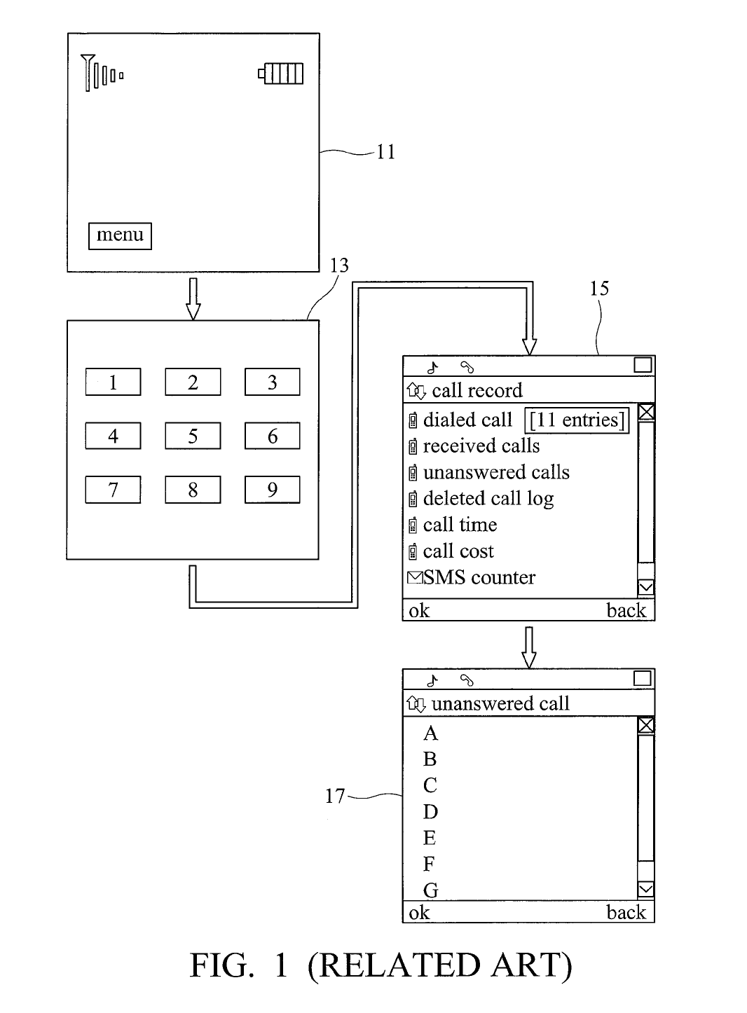

FIG. 2 is a schematic view of an embodiment of a touch screen mobile phone;

FIG. 3 is a flowchart of an embodiment of a method of providing a shortcut icon;

FIG. 4 is a flowchart of an embodiment of a method of utilizing a shortcut icon; and

FIG. 5 is a schematic functional block diagram showing functional components of an embodiment of a mobile phone with a touch screen.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

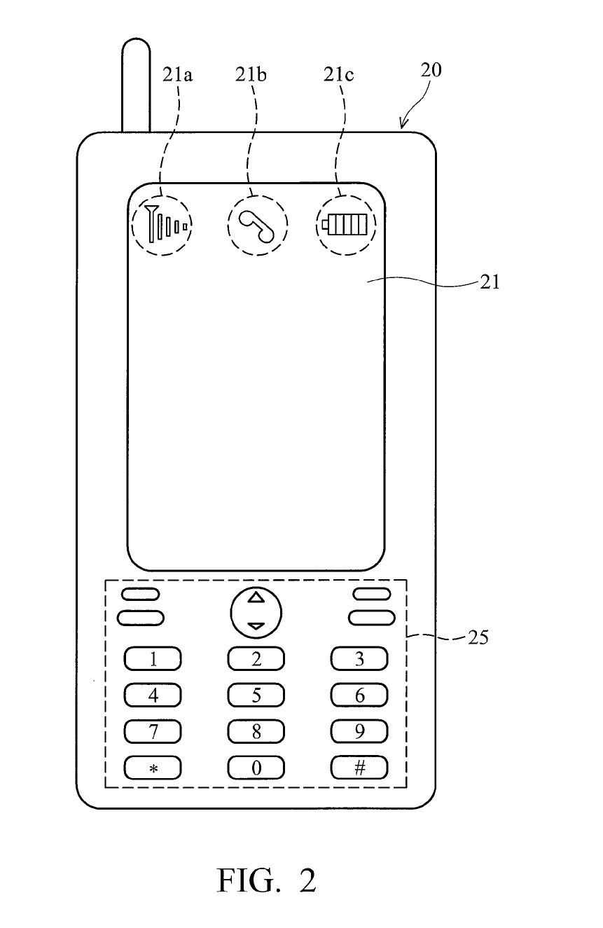

The invention is now described with reference to FIGS. 2 through 5, which generally relate to controlling a mobile phone. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

In the invention, a specific screen is displayed in response to manipulation of a shortcut icon provided on a touch screen without navigating through a hierarchical menu. It should be noted that the invention is applicable to portable devices with a touch screen, such as mobile phones, smart phones, and PDAs (personal digital assistants).

FIG. 2 is a schematic view of a touch screen mobile phone 20 of the invention, comprising a touch screen 21 and a keypad 25. The touch screen 21 is a touch sensitive display screen, displaying a plurality of icons capable of activating specific functions when touched by a stylus. One or more user-defined shortcut icons can be provided on the touch screen 21 in response to user settings. For example, 3 icons are displayed on touch screen 21, wherein icons 21a and 21c are status icons displayed by default, and icon 21b is a user-defined shortcut icon. Icon 21a indicates current signal strength in a communication network. Icon 21c indicates remaining power. Icon 21b is a shortcut icon for an unanswered call list. When the icon 21b is pressed, an unanswered call list is displayed correspondingly. The keypad 250 comprises numeric keys and function keys.

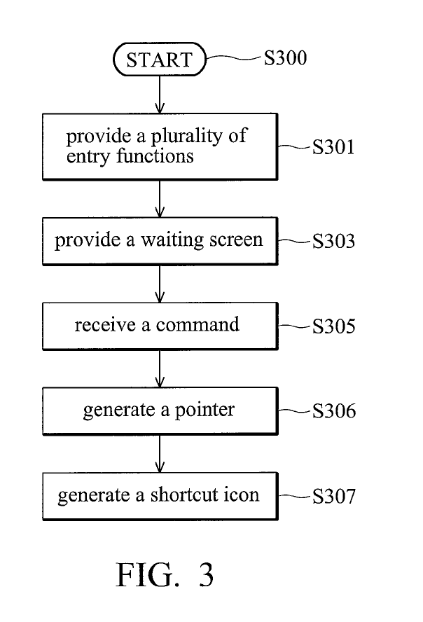

FIG. 3 is a flowchart of an embodiment of a method of providing a shortcut icon. The method is implemented in a touch screen mobile phone, beginning with a start step (step S300). A plurality of entry functions are provided (step S301). These entry functions correspond to items arranged in a hierarchical menu, wherein each of the entry functions operates to display a respective screen. A waiting screen is provided on the touch screen (step S303). Generally, the waiting screen is displayed on the touch screen by default.

In step S305, a command is received, requesting that a pointer is activated or generated and a shortcut icon associated with the pointer is generated. The command can be generated in response to a preset event or a user setting.

For example, the command can be generated automatically when a particular event occurs, such as an unanswered-call event, an alarm-setting event, or other preset events. The event can be designated by a user or a manufacturer.

In addition, the command can be generated in response to a user setting. For example, a command is generated according to a user setting, requesting a pointer directing to a specific page of an e-book to be generated, and a shortcut icon associated with the pointer to be generated. Thus the user can cause the specific page to be displayed simply by pressing the shortcut icon, and resume his/her reading from the specific page without navigating from the first page of the e-book.

In step S306, a pointer is generated in response to the command. The pointer directs to one of the entry functions regardless of the position in the hierarchical menu of the corresponding item. A shortcut icon, associated with the pointer, is then generated on the waiting screen according to the command (step S307).

For example, an incoming call is unanswered. If, without setting of the shortcut icon, a user wants to view a list of unanswered call(s), multiple layers in the hierarchical menu have to be scrolled through. Here, a command is generated in response to the unanswered-call event. A pointer and associated shortcut icon are generated according to the command, wherein the pointer directs to a unanswered call viewing function. The corresponding entry function, i.e, the unanswered call viewing function, is activated when the shortcut icon associated with the pointer is pressed or manipulated in other predetermined ways. When the shortcut icon for unanswered calls is pressed or manipulated in other predetermined ways, the unanswered call viewing function is activated to display a list of unanswered calls. The unanswered calls list is displayed, according to the pointer, in response to pressure exerted the shortcut icon associated with the pointer. In this case, the user can view the unanswered call list with ‘one touch’, rather than by scrolling through layers of the hierarchical menu.

Additionally, the shortcut icon can be associated with a pointer directing to an entry function corresponding to a specific screen. For example, the shortcut icon can be associated with a pointer directing to a message list comprising titles of received short messages; the shortcut icon can be associated with a pointer directing to an alarm setting screen used to set the time, alarm signal, and other specifications pertaining to an alarm function of a mobile phone; the shortcut icon can be associated with a pointer directing to an e-book viewing screen displaying a specific page of an e-book.

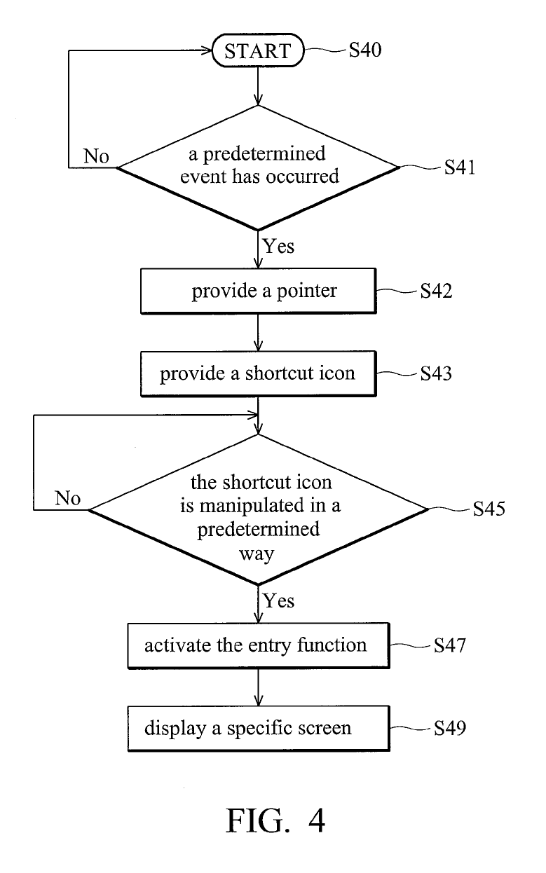

FIG. 4 is a flowchart of an embodiment of a method of utilizing a shortcut icon. FIG. 4 can be implemented in a touch screen mobile phone in which a shortcut icon has been set according to the method of FIG. 3.

Again, the method begins with a start step (step S40) It is determined whether a predetermined event has occurred, for example, an incoming call is unanswered (unanswered call event) (step S41). The predetermined event can be defined to meet requirements, such as a short message arrival event corresponding to an entry function pertaining to viewing/processing short messages. Upon occurrence of the predetermined event, a pointer is provided (step S42), and a shortcut icon associated with the pointer is provided (step S43). In step S45, it is determined whether the shortcut icon is manipulated in a predetermined way, for example, pressed or double-clicked, and if so, the method proceeds to step S47. In step S47, the entry function is activated. In step S49, a specific screen corresponding to the entry function is displayed according to the pointer.

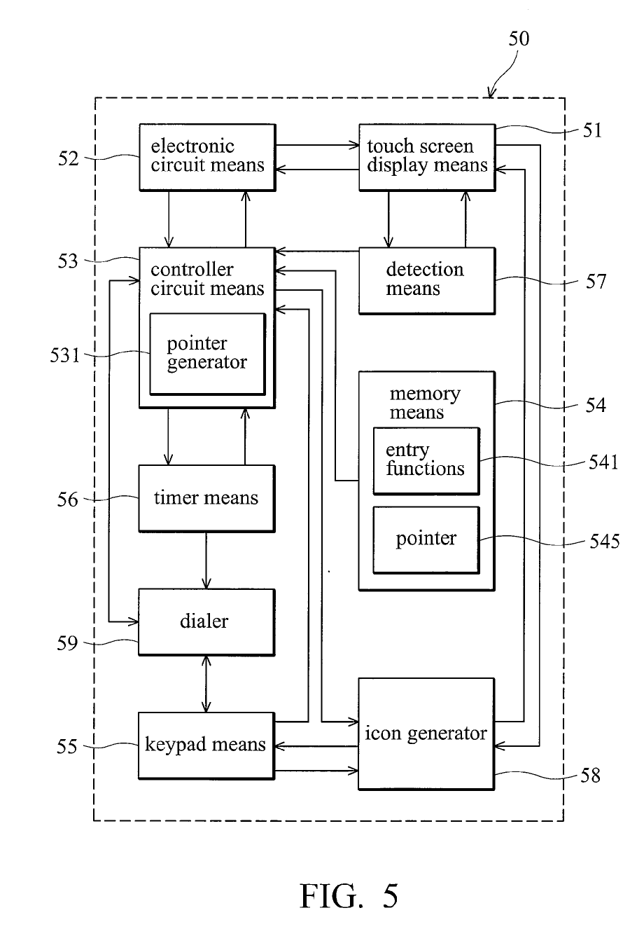

FIG. 5 is a schematic functional block diagram showing functional components of an embodiment of a mobile phone with a touch screen. The mobile phone 50 comprises a touch screen display means 51, electronic circuit means 52, controller circuit means 53, memory means 54, keypad means 55, timer means 56, detection means 57, an icon generator 58, and dialer 59.

The touch screen display means 51 can utilize film-on-glass or other touch screen display technologies known to those skilled in the art. The touch screen display means 51 provides a waiting screen by default.

Electronic circuit means 52 carries out the functions of the mobile phone. Controller circuit means 53 can be part of the electronic circuit means 52 but for purposes of explanation is shown as a separate functional element in FIG. 5, cooperating with an instruction set contained within a memory means 54 and a keypad means 55 for input and function selection. Controller circuit means 53 comprises a pointer generator 531 provides a pointer directing to one of the entry functions regardless of the position in the hierarchical menu of the corresponding item. The memory means 54 stores a plurality of entry functions corresponding to items arranged in a hierarchical menu, wherein each of the entry functions 541 operates to display a respective screen on the touch screen. The memory means 54 also stores at least one pointer 545, wherein each pointer is associated with a shortcut icon and directs to one of the entry functions.

Icon generator 58 generates a shortcut icon associated with the pointer on the waiting screen. Timer means 56 also cooperates with the controller means 53 to carry out various timing functions in accordance with the instruction set retrieved from the memory means 54 via the controller 53. Detection means 57 detects contact with the surface of the touch screen display means 51. The detection means 57 cooperates with the controller means 53. The keypad means 55 contemplates all the keys found on the mobile phone 50. The operation and interconnection of the major functional elements of the mobile phone are well known to those skilled in the art and may be of any appropriate design to carry out the intended functions.

Controller means 53 controls the touch screen display means 51 according to exerted pressure detected by the touch screen contact detection means 57. The control function for the touch screen implemented by the controller means 53 can be realized according to the method described in FIGS. 3 and 4.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of controlling a portable electronic device, comprising:
providing a waiting screen on a touch screen;
providing a plurality of entry functions corresponding to items arranged in a hierarchical menu, wherein each of the entry functions operates to display a respective screen;
providing a pointer directing to one of the entry functions regardless of the position in the hierarchical menu of the corresponding item;
providing a shortcut icon, associated with the pointer, on the waiting screen; and
activating the entry function when the shortcut icon is manipulated in a predetermined way.

2. The method of claim 1, wherein the portable electronic device is a mobile phone.

3. The method of claim 1, further detecting whether the shortcut icon is pressed, and determining whether the shortcut icon is manipulated in the predetermined way.

4. The method of claim 1, further executing the entry function corresponding to the pointer when the shortcut icon is double-clicked.

5. The method of claim 1, executing the entry function corresponding to the pointer when the shortcut icon is pressed longer than a preset time period.

6. The method of claim 1, further providing the shortcut icon when a preset event has occurred.

7. The method of claim 6, further providing the shortcut icon when an unanswered-call event has occurred.

8. The method of claim 7, further displaying screen specifying an unanswered call list when the entry function corresponding to the pointer is executed.

9. The method of claim 6, further providing the shortcut icon when an alarm-setting event has occurred.

10. The method of claim 9, further displaying a screen specifying alarm setting when the entry function corresponding to the pointer is executed.

11. The method of claim 1, further providing the shortcut icon in response to a user setting.

12. A portable electronic device, comprising:
a touch screen providing a waiting screen;
a storage device storing a plurality of entry functions corresponding to items arranged in a hierarchical menu, wherein each of the entry functions operates to display a respective screen on the touch screen;
a pointer generator generating a pointer directing to one of the entry functions regardless of the position in the hierarchical menu of the corresponding item;
an icon generator generating a shortcut icon, associated with the pointer, on the waiting screen; and
a controller determining whether the shortcut icon is manipulated in a predetermined way, and if so activating the entry function corresponding to the manipulated shortcut icon.

13. The portable electronic device of claim 12, wherein the portable electronic device is a mobile phone.

14. The portable electronic device of claim 12, further comprising a detector detecting contact with the surface of the touch screen, and the controller determines whether the shortcut icon is manipulated according to the detector.

15. The portable electronic device of claim 12, wherein the controller executes the entry function corresponding to the pointer when the shortcut icon is double-clicked.

16. The portable electronic device of claim 12, wherein the controller executes the entry function corresponding to the pointer when the shortcut icon is pressed longer than a preset time period.

17. The portable electronic device of claim 12, wherein the pointer generator generates the pointer and the icon generator generates the shortcut icon when a preset event has occurred.

18. The portable electronic device of claim 17, wherein the pointer generator generates the pointer and the icon generator generates the shortcut icon when an unanswered-call event has occurred.

19. The portable electronic device of claim 18, wherein the touch screen further displays a screen specifying an unanswered call list when the entry function corresponding to the pointer is executed.

20. The portable electronic device of claim 17, wherein the pointer generator generates the pointer and the icon generator further generates the shortcut icon when an alarm-setting event has occurred.

21. The portable electronic device of claim 20, wherein the touch screen further displaying a screen specifying alarm setting when the entry function corresponding to the pointer is executed.

22. The portable electronic device of claim 12, wherein the pointer generator generates the pointer and the icon generator further generates the shortcut icon in response to a user setting.
